(19) United States
(12) Patent Application Publication
(10) Pub. No.: US 2023/0073031 A1
(43) Pub. Date: Mar. 9, 2023

(54) KEYBOARD FINGER GUIDE

(71) Applicant: Eugeniu Rotari, Orlando, FL (US)

(72) Inventor: Eugeniu Rotari, Orlando, FL (US)

(21) Appl. No.: 17/986,796

(22) Filed: Nov. 14, 2022

Related U.S. Application Data
(63) Continuation-in-part of application No. 16/804,797, filed on Feb. 28, 2020, now Pat. No. 11,521,509.
Application No. 16/804,797 is a continuation-in-part of application No. 15/984,188, filed on May 18, 2018, now Pat. No. 10,878,716.

(51) Int. Cl. G09B 13/04; G06F 3/02

(52) U.S. Cl. CPC G09B 13/04; G06F 3/0202

(57) ABSTRACT

A keyboard finger guide device includes an elongated divider this is positionable horizontally between two rows of a keyboard, and a plurality of curvilinear guides that are secured to the divider perpendicularly and are positionable vertically between a plurality of individual keys of the keyboard. The guides extend above the top surface of the keyboard keys to provide a constant guide for the first two fingers of a user's left and right hands in the typing position at rest. A keyboard with an integrated finger guide is also provided. The keyboard including a plurality of keys having protrusions along a top surface to act as a guide for receiving and aligning a users fingers according to a 10-finger typing method.

### CROSS-REFERENCE TO RELATED APPLICATIONS

This application is a continuation-in-part to and claims the benefit of copending U.S. application Ser. No. 16/804,797 filed on Feb. 28, 2020, and U.S. Pat. No. 10,878,716 filed on May 18, 2018, the contents of each of which are incorporated herein by reference.

### TECHNICAL FIELD

The present invention relates generally to computer accessories, and more particularly to a finger guide for a keyboard and a keyboard with an integrated finger guide.

### BACKGROUND

The statements in this section merely provide background information related to the present disclosure and may not constitute prior art.

As technology becomes increasingly integrated to our everyday life, the need to type accurately has never been more important. Although most avid computer users are capable of typing fast and accurately in optimum conditions such as when the keyboard is on a flat level surface and ample lighting is available, the job of typing accurately becomes more difficult in less than optimum conditions and/or when the keyboard is out of direct sight as may occur if the user is wearing a virtual reality headset, for example.

For example, when working in low light conditions, such as at home or in a restaurant, for example, users who know how to properly type may find it more difficult to properly arrange all 10 fingers on the keyboard. This is because current keyboards are designed whereby each alphanumeric key includes an identical shape and size, so there is nothing to help guide the user's fingers to the proper resting position. As a result, many mistakes are made which require the user to spend a significant amount of time to correct.

Although there are many known keyboard guide devices which include rigid frames extending far above the keyboard to teach new users' proper hand and finger placement, it is not uncommon for these devices to become separated from the keyboard and lost, thus not enabling the user to benefit from their assistance.

Accordingly, the present invention, directed to a keyboard finger guide and a keyboard with an integrated finger placement guide differs from the conventional art in a number of aspects. The manner by which will become more apparent in the description which follows, particularly when read in conjunction with the accompanying drawings.

### SUMMARY OF THE INVENTION

The present invention is directed to a keyboard finger guide device. One embodiment of the present invention can include an elongated divider this is positionable horizontally between two rows of a keyboard. A pair of curvilinear guides can be secured to the divider perpendicularly and are positionable vertically between a plurality of individual keys of the keyboard.

In one embodiment, the guides can be constructed from a malleable and resilient material and can extend above the top surface of the keyboard keys. The guides can function to provide a constant guide for the first two fingers of a user's left and right hands in the typing position at rest, to reinforce proper placement through constant positive tactile contact.

In one embodiment, the guides can be constructed from a malleable and resilient material and can extend level with the top surface of the keyboard keys at rest. The guides can function to selectively guide the first two fingers of a user's left and right hands while typing to reinforce proper placement through positive tactile contact.

In one embodiment, a keyboard with an integrated finger guide is provided. The keyboard can include a main body having a plurality of keyboard keys extending upward therefrom. Some of the keyboard keys can include uniform shapes and sizes, and other of the keyboard keys can include one or more protrusions extending upward from the top surfaces.

The protrusions can be positioned along the edges of select keyboard keys so as to receive and align all fingers of a user's left and right hand according to a 10-finger typing method. The protrusions also functioning to act as tactile boundaries for each finger while actively typing according to the 10-finger typing method.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a keyboard finger guide that is useful for understanding the inventive concepts disclosed herein.

FIG. 2 is a perspective view of the keyboard finger guide on a keyboard, in accordance with one embodiment of the invention.

FIG. 3 is a perspective view of the keyboard finger guide in operation, in accordance with one embodiment of the invention.

FIG. 4 is another perspective view of the keyboard finger guide on a keyboard, in accordance with one embodiment of the invention.

FIG. 5 is a top view of the keyboard with integrated finger guide, in accordance with one embodiment of the invention.

FIG. 6 is a partial cutout view of the keyboard of FIG. 5 in accordance with one embodiment of the invention.

FIG. 7 is a perspective view of the keyboard with integrated finger guide in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described throughout this document, the term “keyboard” can include any panel having a series of physical switches/keys for use in communicating with any device such as a desktop computer, laptop computer, and/or typewriter, among others for example. As is known in the art, computer keyboards function whereby depression of a particular key closes an electrical circuit with an internal microcontroller which then sends a character code corresponding to the depressed key to a connected computer system over a wire or wirelessly.

As described herein, the term “removably secured” and derivatives thereof shall be used to describe a situation wherein two or more objects are joined together in a non-permanent manner so as to allow the same objects to be repeatedly joined and separated. This can be accomplished through the use of any number of commercially available connectors such as opposing strips of hook and loop material (i.e., Velcro®), magnets, and/or compression fittings such as clips or clamps, for example.

As described herein, the term “permanently secured” and derivatives thereof shall be used to describe a situation wherein two or more objects are joined together in a manner that is intended to prevent the same objects from being separated. Several nonlimiting examples include various adhesives such as glue or resin, welds, and/or through known manufacturing techniques, for example.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

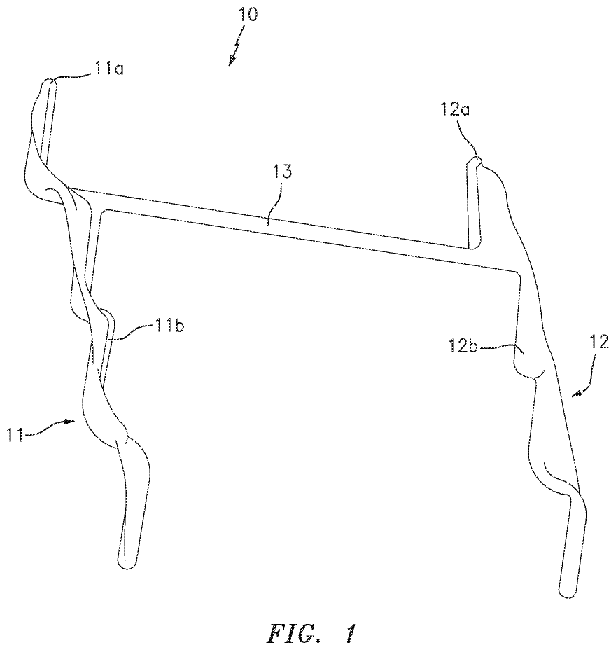

FIGS. 1-4 illustrate various embodiments of a keyboard finger placement guide device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure.

As shown in FIG. 1, one embodiment of the device 10 can include a pair of curvilinear guides 11 and 12 that are positioned parallel to each other and that are connected along the upper ends by an elongated divider 13. The divider 13 can include an elongated, generally planar member that can extend horizontally along a keyboard and can function to maintain the guides 11 and 12 in proper vertical alignment.

In the preferred embodiment, each of the guides 11 and 12 can be constructed from a malleable and resilient material and can include a specific shape and size that is designed to be positioned between a series of vertically offset keys that are found on a standard keyboard. Additionally, each of the guides 11 and 12 can preferably include bright and/or neon colors, for example, that clearly distinguish the guides from a keyboard. Such a feature being beneficial to allow those learning to type to quickly see if their hands are in proper placement along the keyboard.

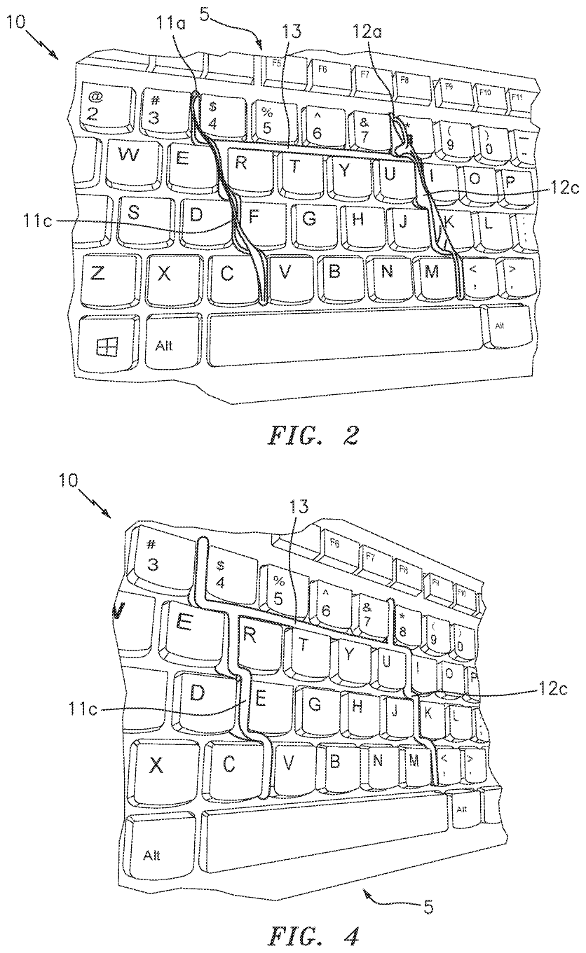

As shown at FIG. 2, one embodiment of the device 10 can be constructed so as to function with a standard QWERTY keyboard 5. In this regard, divider 13 can be positioned horizontally in the space between the number keys and the upper row of letter keys, the top end Ila of guide 11 can be positioned between the number “3” and “4” keys, and the top end 12a of guide 12 can be positioned between the number “7” and “8” keys. Each of the guides 11 and 12 can be designed to include a shape and size that is complementary to the shape and space between the keys of the keyboard, so as to occupy an entirety of this space.

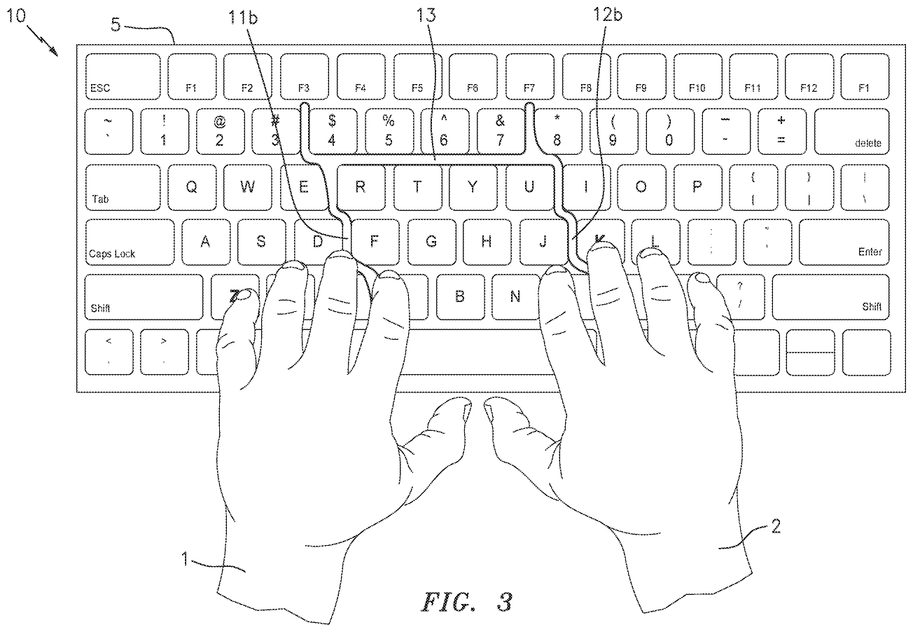

As shown at FIG. 3, when so positioned, the middle section 11b of guide 11 can extend between the “F” and “D” keyboard keys, and that the middle section 12b of guide 12 can be positioned between the “J” and “K” keyboard keys. This placement is an important feature as these keys represent the resting position for the first two fingers (the index and middle fingers) of a user's left hand 1 and right hand 2, respectively so that a user can be provided with a tactile aid for physically aligning their hands and fingers properly on the keyboard.

In the illustrated embodiment, both of the guides 11 and 12 can include a height 11c and 12c, respectively that is greater than a height of the keyboard keys at rest (e.g., raised height”). Such a feature being particularly advantageous for users who are learning how to type on a keyboard proper finger placement through constant positive tactile contact with the raised surface of the guides. As such, students can be provided with a single guide surface for the two main typing fingers on each hand that automatically aligns the other fingers. Additionally, because the guides are raised above the keyboard, the user does not have to look at the keyboard to use the guides.

According to some embodiments, illustrated, for example, in FIGS. 2 and 3, the guide 11 or 12 covers a portion of an upper surface of one or more keyboard keys. For example, guide 11 may cover a portion of upper surface of “C” keyboard key (shown in FIG. 2) and/or a portion of upper surface of “F” keyboard key (shown in FIG. 2) and/or a portion of upper surface of “E” keyboard key (shown in FIG. 3). For example, guide 12 may cover a portion of upper surface of “J” keyboard key (shown in FIG. 2).

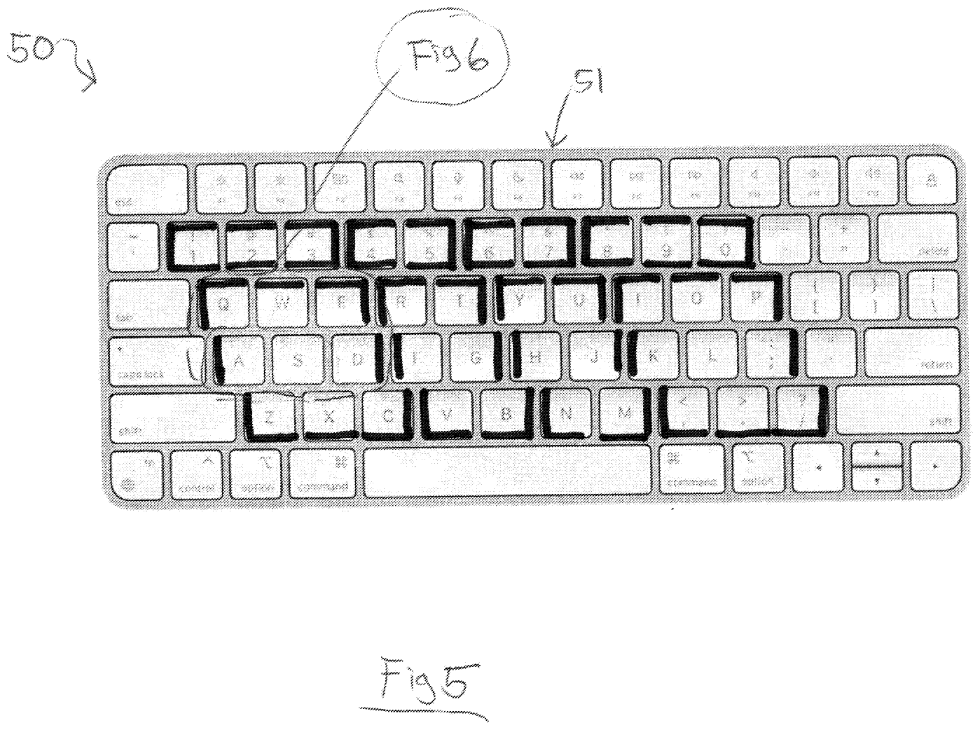

Although described above as extending above the keyboard keys, other embodiments are also contemplated. For example, FIG. 4 illustrates one embodiment of the device 10 wherein the height of the guides 11 and 12 are substantially level with the upper surface of the keyboard keys at rest (e.g., “level height”). In this regard, only when the user depresses keys adjacent to the guide(s) 11 or 12, will they be able to feel the presence of the guides. Such a feature being particularly beneficial for those with intermediate typing skills who no longer need the constant raised guide described above but can benefit from subtle reinforcement of proper hand placement.

According to some embodiments, illustrated, for example, in FIGS. 2 and 4, a portion of the guide 11 is configured to be positioned below upper surface of the keyboard keys at rest. According to some embodiments, illustrated, for example, in FIGS. 2 and 4, a portion of the guide 12 is configured to be positioned below upper surface of the keyboard keys at rest. According to some embodiments, illustrated, for example, in FIGS. 2 and 4, a portion of the elongated divider 13 is configured to be positioned below upper surface of the keyboard keys at rest.

As noted above, one embodiment of the device 10 can be used with industry standard commercially available keyboard having individual keys that are 0.75″×0.75″, and that utilize the QWERTY layout. When so constructed, the following dimensions are critical for ensuring proper use as described above.

In one embodiment, the device 10 can be constructed wherein the horizontal divider 13 includes a height of less than 2mm, and a length of approximately 3.5 inches, so as to extend from the left side of the number “4” keyboard key to the left side of the number “8” keyboard key.

Curvilinear guides 11 and 12 can each include a length of approximately 3 inches, so as to be positionable between the keyboard keys as described above, and can include a raised height of approximately 5 mm, or a level height of approximately 2 mm, for example.

Additionally, because the device 10 is intended to be constantly engaged by a user's fingers, it is important that the guides 11 and 12 may be constructed from a malleable material that can bend and move with the movement of the user's fingers, while also having resilient qualities so as to remain between and/or or to the proper placement between the keyboard keys as described above. Accordingly, in the preferred embodiment, the device 10 and/or guides 11 and 12 can be constructed from rubberized plastic, or other soft polymers, for example. Additionally, the device components may also be constructed to include luminescent properties and may be constructed from composite materials such as clear polymer filled with glitter or other such particles, for example.

Of course, other shapes, sizes, dimensions and/or construction materials are contemplated for keyboards having different shapes, sizes, languages (e.g., non-English alphabets) and/or arrangement of keys, such as the DVORAK layout, for example.

Although described above with regard to a removable guide for an existing keyboard, other embodiments are contemplated wherein the inventive concepts can be integrated into a keyboard itself so as to form a permanent feature.

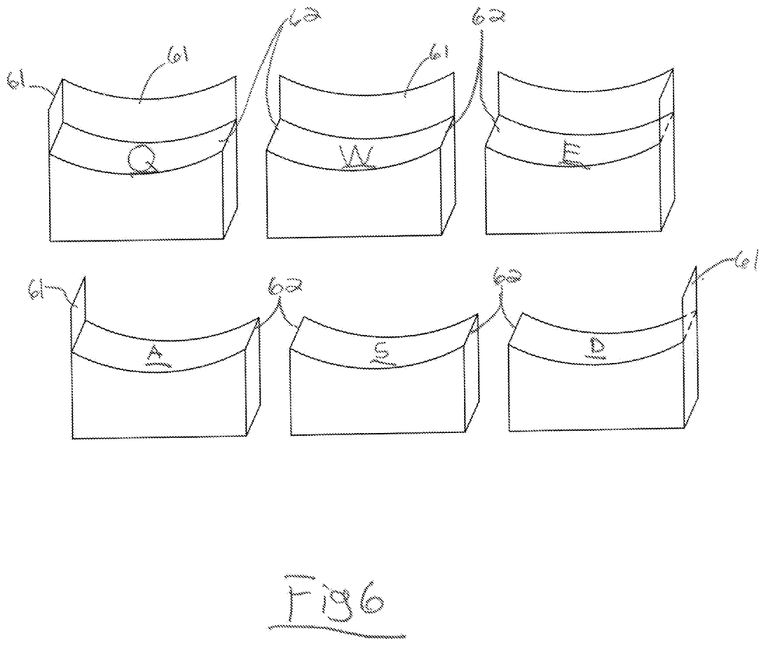

To this end, FIG. 5 illustrates one embodiment of a keyboard with an integrated finger guide 50, that includes a main body 51 having a plurality of keys that are arrayed in a pattern for inputting data. In one embodiment, a finger placement guide can be formed by a series of protrusions that extend upward from several of the keyboard keys.

As shown at the partial cutout view of FIG. 6, each protrusion 61 can extend upward along one or more edges from the select keys so as to create an immediately noticeable tactile aid for allowing the user to quickly and easily align their hands and fingers properly on the keyboard. In the preferred embodiment, each protrusion 61 can extend upward between about 1/64 of an inch to ½ of an inch above the uppermost portion of the top surface 62 of each key. Of course, other dimensions are contemplated.

In the preferred embodiment, the keyboard will include protrusions along select keys to act as a guide in order to teach a user to position their fingers and type via the established 10-finger typing method whereby the users left hand fingers are placed on the keys “A”, “S”, keys “D” and “F” keys; the users right hand fingers are placed on the “J”, “K”, “L” and “;” keys; and the users thumbs are placed on the space bar.

To this end, the following keys can include protrusions as follows wherein terms left, right, bottom and top relate to the keyboard as shown at FIG. 5:
Single protrusion on left edge of keys “A”, “F”, “H” and “K”.
Single protrusion on right edge of keys “D”, “G”,“J”, and “; ”.
Single protrusion on top edge of keys “W” and “O”.
Single protrusion on bottom edge of keys “X” and “.”.
Two protrusions on top and bottom edges of keys “2” and “9”.
Two protrusions on top and left edges of keys “Q”, “R”, “Y”, and “I”.
Two protrusions on top and right edges of keys “E”, “T”, “U”, and “P”.
Two protrusions on left and bottom edges of keys “Z”, “V”, “N”, and “,”.
Two protrusions on right and bottom edges of keys “C”, “B”, “M”, and “/”.
Three protrusions on top, bottom, and left edges of keys “1”, “4”, “6”, and “8”.
Three protrusions on top, bottom, and right edges of keys “3”, “5”, “7”, and “0”.

In various embodiments, each of the protrusions can be formed from an identical material as the keyboard key so as to be manufactured as a unitary element. In some embodiments, the protrusions can be manufactured separately and can be permanently secured onto the noted portions of the specified keys by an adhesive or other such material.

In some embodiments, the protrusions may be coated with or constructed from rubberized plastic, or other soft polymers, for example, so as to provide a distinctive feel to a user that is different from that of the keyboard keys themselves. In such an embodiment, the protrusions may also include luminescent properties and/or colors that are different from the keyboard keys so as to be visually distinct from the keys which do not have the attached protrusions.

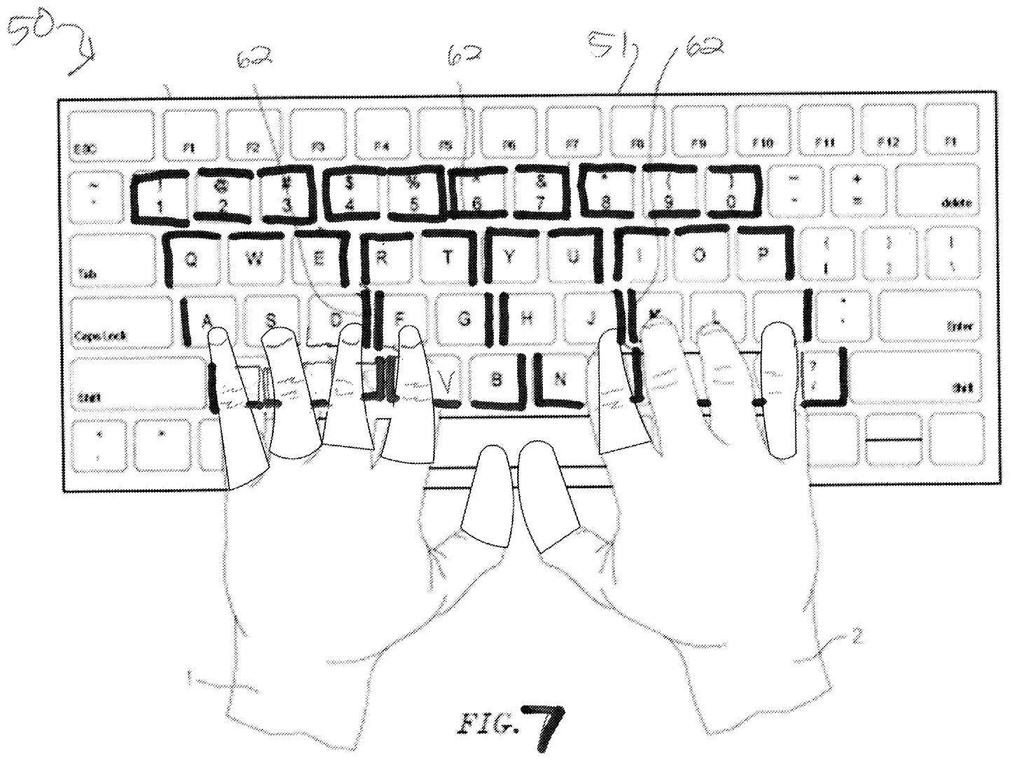

FIG. 7 illustrates one embodiment of the keyboard with integrated finger guides 50 in operation. As shown, when a user places their fingers onto the keyboard, the index finger, middle finger, ring finger and little finger of their left hand 1 can be positioned on the “F”, “D”, “S” and “A” keyboard keys, respectively, the index, middle, ring and little fingers of their right hand 2 can be positioned on the “J”, “K”, “L” and “;” keyboard keys, respectively. In this regard, the protrusions extending upward from the adjacent edges of the F-D and J-K keys, respectively provide a tactile aid for physically aligning the first two fingers of each hand on the keyboard prior to typing.

From this position, each finger can type according to the established 10-finger method whereby the protrusions along the other keys provide continuous tactile boundaries (e.g., upper, bottom and side to side limits) so the user can immediately recognize what key each finger is touching without having to look at the keyboard. Such a feature being particularly beneficial when typing in low light situations and/or for users who are switching from the “hunt and peck” methodology to full 10-finger typing.

Although illustrated with regard to a keyboard that is arranged in the standardized QWERTY layout having English letter alphabetical keys, numeric keys, special function keys, arrow keys, and command keys, this is for illustrative purposes only. To this end, other embodiments are contemplated wherein the keyboard includes a different layout, a different language (e.g., non-English alphabets) and/or a different number or arrangement of keys, such as the DVORAK layout, for example.

Additionally, although described and illustrated with regard to use for the 10-finger typing method, other embodiments are contemplated wherein the protrusions are positioned along different keys or different surfaces of the same keys in order to align and position one or more fingers of one or both hands of a user according to other typing methods.

As described herein, one or more elements of the keyboard finger placement guide and the keyboard with integrated guide can be secured together utilizing any number of known attachment means such as, for example, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous element, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A keyboard, comprising:
a main body having a top surface, a bottom surface and a plurality of side walls; and
a first plurality of keyboard keys that are positioned along the main body, each of the first plurality of keyboard keys including a top surface having a uniform height relative to each other; and
a second plurality of keyboard keys that are positioned along the main body, each of the second plurality of keyboard keys including a top surface having at least one protrusion extending upward therefrom.

2. The keyboard of claim 1, wherein the second plurality of keyboard keys are configured to engage and align all fingers of a users left hand and all fingers of a users right hand onto the keyboard according to a 10-finger typing method.

3. The keyboard of claim 2, wherein each of the at least protrusion on each of the second plurality of keyboard keys are configured to independently engage at least one of the fingers on the users left hand and right hand.

4. The keyboard of claim 2, wherein each of the at least one protrusion acts as a tactile boundary for maintaining all fingers of the users left hand and all fingers of the users right hand on the keyboard when typing according to the 10-finger typing method.

5. The keyboard of claim 1, wherein the second plurality of keyboard keys includes a letter F keyboard key, and the protrusion extends upward along a left side edge of the letter F keyboard key.

6. The keyboard of claim 5, wherein the keyboard key F is configured to receive an index finger of a users left hand, and the protrusion is configured to act as a tactile boundary for engaging a left side of the index finger.

7. The keyboard of claim 1, wherein the second plurality of keyboard keys includes a letter D keyboard key, and the protrusion extends upward along a right side edge of the letter D keyboard key.

8. The keyboard of claim 7, wherein the keyboard key D is configured to receive an middle finger of a users left hand, and the protrusion is configured to act as a tactile boundary for engaging a right side of the middle finger.

9. The keyboard of claim 1, wherein the second plurality of keyboard keys includes a letter J keyboard key, and the protrusion extends upward along a right side edge of the letter J keyboard key.

10. The keyboard of claim 9, wherein the keyboard key J is configured to receive an index finger of a users right hand, and the protrusion is configured to act as a tactile boundary for engaging a right side of the index finger.

11. The keyboard of claim 1, wherein the second plurality of keyboard keys includes a letter K keyboard key, and the protrusion extends upward along a left side edge of the letter K keyboard key.

12. The keyboard of claim 11, wherein the keyboard key K is configured to receive a middle finger of a users right hand, and the protrusion is configured to act as a tactile boundary for engaging a left side of the middle finger.

13. The keyboard of claim 1, wherein each of the first plurality of keyboard keys and the second plurality of keyboard keys include at least one of an alphanumeric identifier or a punctuation identifier.

14. The keyboard of claim 1, wherein the first plurality of keyboard keys and the second plurality of keyboard keys are arranged in a QWERTY layout.
